(19) United States
(12) Patent Application Publication
(10) Pub. No.: US 2022/0319354 A1
(43) Pub. Date: Oct. 6, 2022

(54) GOOD DRIVER SCORECARD AND DRIVER TRAINING

(71) Applicant: Veoneer US, Inc., Southfield, MI (US)

(72) Inventors: Caroline Chung, Royal Oak, MI (US); Thomas J. Herbert, Fenton, MI (US); Francis J. Judge, South Lyon, MI (US)

(73) Assignee: Veoneer US, Inc., Southfield, MI (US)

(21) Appl. No.: 17/620,602

(22) PCT Filed: Jun. 18, 2020
(86) PCT No.: PCT/US2020/038382

§ 371 Date: Dec. 17, 2021

Related U.S. Application Data
(60) Provisional application No. 62/863,130, filed on Jun. 18, 2019.

(51) Int. Cl. G09B 19/16; B60W 40/09

(52) U.S. Cl. CPC G09B 19/167; B60W 40/09

(57) ABSTRACT

A system for evaluating performance of a driver of a vehicle with an electronic control unit is provided. The system includes an evaluation processor configured to access driving dynamics data regarding operation of the vehicle, and a driver monitoring sensor in communication with the evaluation processor to generate driver status data that relates to a position, orientation, or condition of the driver. One or more external monitoring sensors are in communication with the evaluation processor to generate external interaction data relating to interaction of the driver with an external environment. The evaluation processor is configured to generate a driver rating based upon the driving dynamics data and the driver status data and the external interaction data. A method for evaluating performance of a driver of a vehicle is also provided.

### CROSS-REFERENCE TO RELATED APPLICATION

The present application claims the benefit of the filing date of U.S. Provisional Application No. 62/863,130, filed Jun. 18, 2019, the disclosure of which is hereby incorporated herein by reference in its entirety.

### BACKGROUND

### 1. Field of the Invention

The present application generally relates to a system for evaluating performance of a driver.

### SUMMARY

A system for evaluating performance of a driver of a vehicle with an electronic control unit is provided. The system includes an evaluation processor configured to access driving dynamics data regarding operation of the vehicle, and a driver monitoring sensor in communication with the evaluation processor. The driver monitoring sensor is configured to generate driver status data that relates to a position, orientation, or condition of the driver. The system also includes an external monitoring sensor in communication with the evaluation processor. The external monitoring sensor is configured to generate external interaction data relating to interaction of the driver with an external environment. The evaluation processor is configured to generate a driver rating based upon the driving dynamics data and the driver status data and the external interaction data.

A method for evaluating performance of a driver of a vehicle is also provided. The method comprises the steps of: receiving, by an evaluation processor, driving dynamics data regarding operation of the vehicle; generating, by a driver monitoring sensor in communication with the evaluation processor, driver status data that relates to a position, orientation, or condition of the driver; generating, by an external monitoring sensor in communication with the evaluation processor, external interaction data relating to interaction of the driver with an external environment; and computing, by the evaluation processor, a driver rating based upon the driving dynamics data and the driver status data and the external interaction data.

Further objects, features, and advantages of this application will become readily apparent to persons skilled in the art after a review of the following description, with reference to the drawings and claims that are appended to and form a part of this specification.

### BRIEF DESCRIPTION OF THE DRAWINGS

FIG. 1 is a flowchart illustrating a method for determining a driver rating.

FIG. 2 is a schematic diagram for a driver monitor.

FIG. 3A is a schematic diagram of a vehicle with sensors for monitoring the driver and outside environmental attributes.

FIG. 3B is a schematic diagram of a vehicle illustrating a communication and alert system.

FIG. 4 is a block diagram illustrating the determining of the driver rating.

### DETAILED DESCRIPTION

Driver feedback may be based either on set driver metrics (attention, engagement, drowsiness, etc) or vehicle dynamics feedback (acceleration, braking, inertial measurements, etc). However, no focus has been put on incorporating actual driver gaze behavior or driver visual monitoring into a system to provide feedback to the driver and/or other entities

Systems may give warnings (haptic, audible, visual alerts) based on set driver metrics, and other systems may compile vehicle dynamic data for driver rating systems like GM's “Teen Driver.” One large gap that has not received consideration includes combining external data (radars, cameras, LiDAR, etc), driver monitoring, and vehicle data for a holistic solution.

The application could be for an improvement on existing Teen Driver/vehicle dynamic based systems, information for insurance agencies to reward low-risk drivers, for driver training to aid in fostering better driving behaviors, or for a general driver “scorecard” that provides feedback on driving metrics.

In one example, a first driver has normal acceleration, braking, keeps within speed limits, is engaged while driving, does not eat or use his cell phone, and always checks for pedestrians both ways at stop signs and cross walks. The first driver may get a great score.

A second driver never uses her seatbelts, speeds, drives while drowsy, does her make-up in the car, angrily yells at other drivers while driving, and does not check blind spots. The second driver may get a bad score with a full breakdown of the items negatively affecting the score.

A third driver may be great at keeping a decent following distance, but does not keep to his lane all the time. He thinks about work sometimes, taking away the focus from driving, but is mostly alert and engaged. The third driver may get a mediocre score, with a breakdown of items that he can improve on.

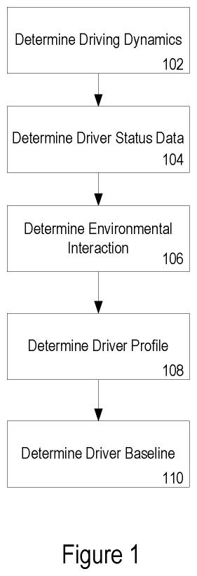

Referring to FIG. 1, a flow chart illustrating a method of driver ranking is provided. Driving dynamics are determined in step 102. The driving dynamics are the metrics typically used for driver rating because they are generally available in the vehicle and accessible through communications with one or more onboard controllers. The driving dynamics may be available, for example, via an onboard diagnostics (OBD) port. The driving dynamics may include braking characteristics such as hard brakes, acceleration, and/or maximum speed of the vehicle. In addition, driving dynamics may include stability control events and/or forward collision alerts. The driving dynamics may also include distance from other vehicles (e.g. following distance), seatbelt usage and/or lane keeping data (e.g., indicating lane change information as well as how well the vehicle stays in the lane) as well as compliance speed limits.

In step 104, the driver status data may be determined for example, through driver monitoring sensors. The driver monitor may be executed by a number of sensors as described elsewhere in this application. The driver status data may include attention zones, engagement of the driver, whether the driver is performing secondary tasks such as eating, drinking, etc., whether the driver has his hands on the steering wheel, impairment of the driver, drowsiness of the driver, the cognitive mode of the driver, emotion of the driver, as well as, alert responsiveness.

In step 106, the environmental interaction is determined. The environmental interaction may include any action by the driver in controlling the vehicle to interact with the outside environment. Specifically, one or more external monitoring sensors is configured to generate external interaction data relating to interaction of the driver with an external, or outside, environment. The external interaction data may be determined by a number of outward looking sensors attached to the vehicle. The environmental interaction may include, for example, the driver's awareness of imminent events, looking for pedestrians on crosswalks, checking blind spots before lane changes, performing full stops at stop signs, or running a red light. In step 108, a driver profile may be generated based on the driver status data and the external interaction data. The driver profile may be uploaded to a network server and may be accessed by various vehicles based on the driver of that vehicle. In some implementations, the driver profile may be loaded onto a mobile device for example, a cell phone, which may then be accessed by the vehicle for example by Wi-Fi when the driver enters the vehicle or when selected by the driver either through the vehicle or through an app on the mobile device. In step 110, a driver baseline is determined. The driver baseline may include the data provided in the driver profile. However, the driver baseline may provide values for each attribute of the driver under a normal (e.g. standardized) conditions. Accordingly, the driver profile over a certain period of time may then be compared to the driver baseline to determine whether the driver is acting substantially different from the norm for that driver in any one of the recorded attributes.

In some embodiments, the evaluation processor may be configure to alert the driver when a currently measured attribute deviates by a first threshold amount from the driver baseline. For example, an audible, haptic, or visual indicator may be presented to the driver in response to determining that the driver is deviating from one or more attributes of the driver baseline by a corresponding first threshold amount. The alert may be tailored to the measured attribute or attributes that deviate from the first threshold. For example, the system may provide one warning message in response to determining that the driver is excessively drowsy, and the system may provide a different warning message in response to determining that the driver is excessively distracted and that the distractions are or could adversely affect their driving ability.

In some embodiments, the evaluation processor may be configure to alert a remote system when a currently measured attribute deviates by a second threshold amount from the driver baseline. In some embodiments, the second threshold may be the same as the first threshold. In some other embodiments, the second threshold may be greater, or farther from the driver baseline than the first threshold. For example, a driver may receive an alert in response to a measured attribute, such as driver drowsiness exceeding the first threshold; and if the driver fails to take corrective action and if the measured attribute continues such that it exceeds the second threshold, the remote system may be alerted. The remote system may be, for example, a server that tracks commercial driving behavior.

For example, a warning message or visual indicator may be presented to the driver in response to determining that the driver is substantially deviating from the driver baseline. Such a warning message or indicator may be tailored to the measured attribute or attributes that deviate from the first threshold. For example, the system may provide one warning message in response to determining that the driver is excessively drowsy, and the system may provide a different warning message in response to determining that the driver is excessively distracted and that the distractions are or could adversely affect their driving ability.

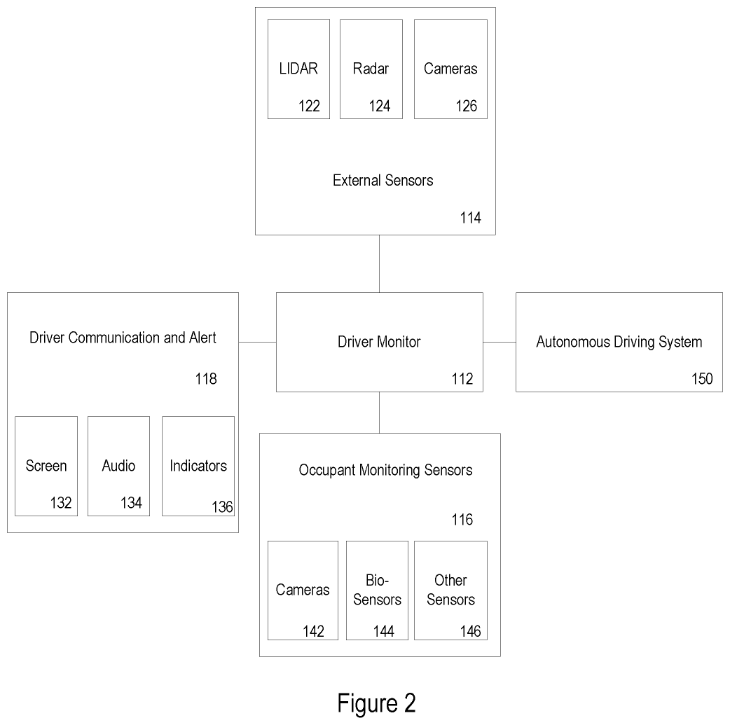

FIG. 2 is a schematic view of a driver monitor 112. The driver monitor may determine a driver profile and driver baseline as described elsewhere in this application. In accomplishing these tasks, the driver monitor 112 may be in communication with external sensors 114. The external sensors may monitor the environment surrounding the vehicle as the vehicle is stopped or as the vehicle proceeds along its route. The external sensors may include Lidar 122, radar 124, and cameras 126. However, it is understood that other external sensing technologies may be used, for example, ultrasonic sensors or other distance or environmental measuring sensors within the vehicle. In some examples, the sensors may include temperature sensors, moisture sensors, as well as, various features that may be derived from sensors such as the camera. These features may include whether there is a snowy condition, the amount of glare from the sun, or other external environmental conditions. The driver monitor system 112 may use input from the external sensors 114 to provide environmental context to the driver monitor 112 when determining the driver profile and/or baseline. The driver monitor 112 may also be in communication with an occupant monitoring sensors system 116. The occupant monitoring system 116 may include cameras 142, biosensors 144, as well as other sensors 146. The cameras may be mounted in different positions, orientations, or directions within the vehicle to provide different viewpoints of occupants in the vehicle. The cameras may be used to analyze gestures by the occupants or determine the positon and/or orientation of the occupant, or monitor indications of the occupant such as facial features indicative of emotion or condition. The biosensors 144 may include touch sensors for example, to determine if the driver is touching a certain control such as the steering wheel or gear shift. The biosensors 144 could include a heart rate monitor to determine the heart rate of the passenger, as well as, other biological indications such as temperature or skin moisture. In addition, other sensors 146 may be used such as presence, absence or position sensors to determine for example, if the occupant is wearing a safety belt, a weight sensor to determine the weight of the occupant. The driver monitor 112 may use the occupant monitoring data from the occupant monitoring sensor systems to determine the driver profile and/or baseline.

The driver monitor 112 may also be in communication with a driver communication and alert system 118. The driver communication and alert system 118 may include video screens 132, audio system 134, as well as other indicators 136. The screen may be a screen in the console and may be part of the instrument cluster, or a part of a vehicle infotainment system. The audio may be integrated into the vehicle infotainment system or a separate audio feature for example, as part of the navigation or telecommunication systems. The audio may provide noises such as beeps, chirps or chimes or may provide language prompts for example, asking questions or providing statements in an automated or pre-recorded voice. The driver communication and alert system 118 may also include other indicators for example, lamps or LEDs to provide a visual indication or stimulation either on the instrument cluster or elsewhere in the vehicle including for example, on the side view mirrors or rear view mirror.

The driver monitor 112 may also be in communication with an autonomous driving system 150. The autonomous driving system 150 may utilize the driver profile and driver baseline information for making various decisions for example, when and how to provide vehicle control handoff, when making decisions about drivers and objects (e.g. people, vehicles, etc.) around the current vehicle. In one example, a vehicle-to-vehicle communication system may provide information about a driver in a nearby car based on the driver information system and the autonomous driving system 150 may make driving decisions based on the driver profile and/or driver baseline of drivers in surrounding vehicles.

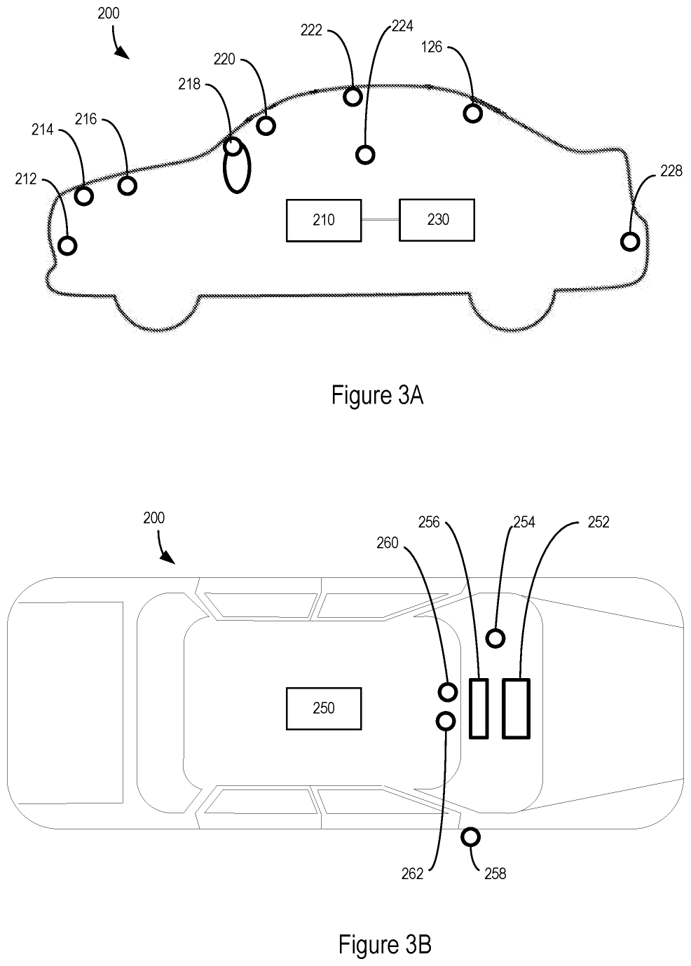

Now referring to FIG. 3A, a schematic view of the vehicle 200 is provided. The vehicle may include a sensor processer 210. The sensor processer 210 may include one or more processors to monitor and/or measure the input from various vehicle sensors both inside or outside of the vehicle. For example, as described previously, the vehicle may include a range sensor 212, for example, an ultrasonic sensor to determine if an object is directly from another vehicle 200. The vehicle may include a radar sensor 214. The radar sensor 214 may be a forward looking radar sensor and provide distance and location information of objects that are located within the radar sensing field. As such, a vehicle may include a forward facing radar shown as radar 214. However, a rearward or sideward looking radar may also be included. The system may include a Lidar 216. The Lidar 216 may provide distance and location information for vehicles that are within the sensing field of the Lidar system. As such, the vehicle may include a forward looking Lidar system as shown with regard to Lidar 216. However, rearward or sideward looking Lidar systems may also be provided.

The vehicle 200 may also include biosensors 218. The biosensor 218 may for example, be integrated into a steering wheel of the vehicle. However, other implementations may include integration into seats and/or a seatbelt or within other vehicle controls such as the gear shift or other control knobs. Biosensor 218 may determine a heartbeat, temperature, and/or moisture of the skin of the driver of the vehicle. As such, the condition of the driver may be evaluated by measuring various biosensor readings as provided by the biosensor 218. The system may also have one or more inward or cabin facing cameras 220. The cabin facing cameras 220 may include cameras that operate in the white light spectrum, infrared spectrum, or other available wavelengths. The cameras may be used to determine various gestures of the driver, position or orientation of the driver, or facial expressions of the driver to provide information about the condition of the driver (e.g. emotional state, engagement, drowsiness and impairment of the driver). Further, bioanalysis may be applied to the images from the camera to determine the condition of the driver or if the driver has experienced some symptoms of some medical state. For example, if the driver's eyes are dilated, this may be indicative of a potential medical condition which could be taken into account in controlling the vehicle. As, such, condition of the driver may be determined based on a combination of measurements from one or more sensors. For example, a heart rate in a certain range, a particular facial expression, and skin coloring within a certain range may correspond to a particular emotional state, engagement, drowsiness and/or impairment of the driver.

Cameras 222 may be used to view the external road conditions, such as in front of, behind, or to the side of the vehicle. This may be used to determine the path of the road in front of the vehicle, the lane indications on the road, the condition of the road with regard to road surface, or with regard to the environment external to the vehicle including whether the vehicle is in a rain or snow environment, as well as, lighting conditions external to the vehicle including whether there is glare or glint from the sun or other objects surrounding the vehicle as well as the lack of light due to poor road lighting infrastructure. As discussed previously, the vehicle may include rearward or sideward looking implementations of any of the previously mentioned sensors. As such, a side view mirror sensor 224 may be attached to the side view mirror of the vehicle and may include a radar, Lidar and/or camera sensor for determining external conditions relative to the vehicle including the position of objects such as other vehicles around the instant vehicle. Additionally, rearward facing camera 226 and ultrasonic sensor 228 in the rear bumper of the vehicle provide other exemplary implementations of rearward facing sensors that parallel the functionality of the forward facing sensors described previously.

The vehicle may also include an evaluation processor 230 configured to access driving dynamics data regarding operation of the vehicle. For example, the evaluation processor 230 may be in functional communication with the sensor processer 210. The evaluation processor 230 may be and in functional communication with a driver monitoring sensor configured to generate driver status data that relates to a position, orientation, or condition of the driver. The evaluation processor 230 may also be in functional communication with an external monitoring sensor configured to generate external interaction data relating to interaction of the driver with an external environment. The evaluation processor 230 may be configured to generate a driver rating based upon the driving dynamics data and the driver status data and the external interaction data. In some embodiments, the evaluation processor 230 may be a stand-alone unit. In some other embodiments, the evaluation processor 230 may be implemented integrally with one or more other processors, such as sensor processer 210.

With regard to FIG. 3B, a vehicle 200 may include a vehicle communication and alert processor 250. The vehicle communication and alert processor 250 include one or more processors and may be in communication with various communication devices such as screens, audio, as well as, other indicators within the vehicle to alert and/or communicate certain items of information with the occupant of the vehicle. The vehicle may include a video display 252 that may be part of the instrument cluster or part of the vehicle entertainment system. An indicator 254 which may also be part of the instrument cluster or may take the form of a heads-up or windshield projector indicator. In addition, the system may provide stimulus to the occupant through an indicator on the rearview mirror 256 or the side mirror 258. Further, communication may be provided between the system and the occupant through audio. For example, a speaker 260 and a microphone 262 may provide sound indicators or verbal communication between the occupant and the processor 250.

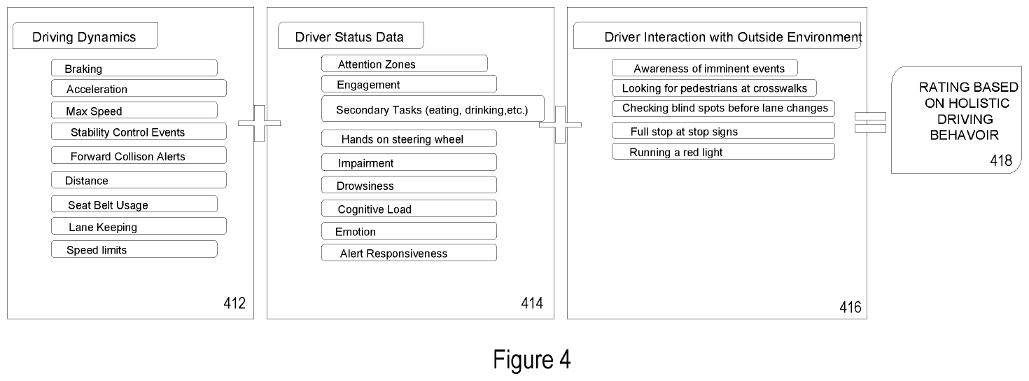

Referring to FIG. 4, a flow chart illustrating a method of driver ranking is provided. The driving dynamics data 412 may be combined with the driver status data 414 and/or the driver interaction with the outside environment data 416 to determine a driver rating 418 that represents a holistic driving behavior. In some implementations, the driver rating 418 may be generated by rating each of the driving dynamics data 412, driver status data 414, and driver interaction with the outside environment data 416 separately, weighting each rating, then combining the ratings. In some implementations, each attribute of the driving dynamics data 412, driver status data 414, and driver interaction with the outside environment data 416 may be independently weighted then combined to determine the driver rating 418. The driving dynamics may include braking characteristics such as hard brakes, acceleration, maximum speed of the vehicle. In addition, driving dynamics may include stability control events, as well as, forward collision alerts. The driving dynamics may also include distance from other vehicles (e.g. following distance), seatbelt usage and/or lane keeping data (e.g., indicating lane change information as well as how well the vehicle stays in the lane) as well as compliance with speed limits.

The driver status data 414 may be generated by a driver monitoring system including sensors configured to monitor the driver. The driver status data 414 may include attention zones, engagement of the driver, whether the driver is performing secondary tasks such as eating, drinking, etc., whether the driver has his hands on the steering wheel, impairment of the driver, drowsiness of the driver, the cognitive mode of the driver, emotion of the driver, as well as alert responsiveness. One or more external monitoring sensors, such as outward looking sensors attached to the vehicle, are configured to generate external interaction data relating to interaction of the driver with an external, or outside, environment. The environmental interaction may include, for example, the driver's awareness of imminent events, looking for pedestrians on crosswalks, checking blind spots before lane changes, performing full stops at stop signs, or running a red light. In some embodiments, the driver rating 418 may be compared to a driver baseline. The driver baseline may include the data provided in a data driver profile. However, the driver baseline may provide values for each attribute of the driver under a normal (e.g. standardized) conditions. Accordingly, the driver profile over a certain period of time may then be compared to the driver baseline to determine whether the driver is acting substantially different from the norm for that driver in any one of the recorded attributes.

A method for evaluating performance of a driver of a vehicle is also provided. The method comprises receiving, by an evaluation processor, driving dynamics data regarding operation of the vehicle. The driving dynamics data may include measured and/or computed data from one or more systems and sensors within the vehicle. The driving dynamics data may include, for example, braking data, acceleration data, maximum speed, stability control events, forward collision alerts, distance from other vehicles, seatbelt usage, lane keeping, and/or data regarding compliance with speed limits.

The method also includes generating, by a driver monitoring sensor in communication with the evaluation processor, driver status data that relates to a position, orientation, or condition of the driver. The driver status data may include, for example, attention zones, engagement of the driver, whether the driver is performing secondary tasks such as eating, drinking, etc., whether the driver has his hands on the steering wheel, impairment of the driver, drowsiness of the driver, the cognitive mode of the driver, emotion of the driver, and/or alert responsiveness.

In some embodiments, the step of generating the driver status data may further include the sub-step of determining a direction that the driver is looking based on data from a camera that is positioned such that the driver is in a field of view of the camera.

In some embodiments, the step of generating the driver status data may further include the sub-step of determining driver contact with a steering wheel of the vehicle. The driver contact may be a binary (yes/no) determination. Alternatively, the driver status data may include specific information regarding the specifics of driver contact with the steering wheel (e.g. how many hands on the wheel, placement of hands on the wheel, etc.).

The method also includes generating, by an external monitoring sensor in communication with the evaluation processor, external interaction data relating to interaction of the driver with an external environment. The external interaction data may describe, for example, the driver's awareness of imminent events, looking for pedestrians on crosswalks, checking blind spots before lane changes, performing full stops at stop signs, or running a red light.

The method also includes the step of computing, by the evaluation processor, a driver rating based upon the driving dynamics data and the driver status data and the external interaction data.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

As a person skilled in the art will readily appreciate, the above description is meant as an illustration of the principles of this application. This description is not intended to limit the scope or application of the claim in that the assembly is susceptible to modification, variation and change, without departing from spirit of this application, as defined in the following claims.

1. A system for evaluating performance of a driver of a vehicle with an electronic control unit, the system comprising:
an evaluation processor configured to access driving dynamics data regarding operation of the vehicle;
a driver monitoring sensor in communication with the evaluation processor, the driver monitoring sensor configured to generate driver status data that relates to a position, orientation, or condition of the driver; and
an external monitoring sensor in communication with the evaluation processor, the external monitoring sensor configured to generate external interaction data relating to interaction of the driver with an external environment;
wherein the evaluation processor is configured to generate a driver rating based upon the driving dynamics data and the driver status data and the external interaction data, and
wherein the evaluation processor is configured to generate an alert to the driver or to a remote system based on the driving dynamics data and the external interaction data.

2. The system of claim 1, wherein the evaluation processor is configured to generate a driver profile including measured attributes of the driver, the measured attributes including the driving dynamics data and the external interaction data.

3. The system of claim 2, wherein the evaluation processor calculates a driver baseline based on the driving dynamics and the external interaction data associated with the driver profile.

4. The system of claim 3, wherein the evaluation processor is configured to alert the driver when a currently measured attribute deviates by a first threshold amount from the driver baseline.

5. The system of claim 3, wherein the evaluation processor is configured to alert a remote system when a currently measured attribute deviates by a second threshold amount from the driver baseline.

6. The system of claim 3, wherein the evaluation processor is configured to update the driver baseline as additional measurements become available.

7. The system of claim 2, wherein the evaluation processor is configured to store the driver profile in a memory located within the vehicle.

8. The system of claim 2, wherein the evaluation processor is configured to store the driver profile remote from the vehicle.

9. The system of claim 1, wherein the driving dynamics data includes at least one of: braking data, acceleration data, maximum speed, a stability control event, a forward collision alert, distance from other vehicles, seatbelt usage, lane keeping, or data regarding compliance with a speed limit.

10. The system of claim 1, wherein the driver status data includes at least one of: attention zone, driver engagement, secondary tasks of the driver, hands on a steering wheel, impairment of the driver, drowsiness of the driver, cognitive load of the driver, emotion of the driver, or alert responsiveness of the driver.

11. The system of claim 1, wherein the external interaction data includes at least one of: driver awareness of imminent events, looking for pedestrians at crosswalks, checking blind spots before lane changes, full stop at stop signs, or running a red light.

12. The system of claim 1, wherein the driver monitoring sensor comprises a camera positioned such that the driver is in a field of view of the camera, and the driver monitoring sensor being configured to determine a direction that the driver is looking based on data from the camera.

13. The system of claim 1, wherein the driver monitoring sensor comprises a bio-sensor configured to determine a heart rate of the driver.

14. The system of claim 1, wherein the driver monitoring sensor comprises a steering sensor configured to determine contact between the driver and a steering wheel.

15. A method for evaluating performance of a driver of a vehicle, the method comprising:
receiving, by an evaluation processor, driving dynamics data regarding operation of the vehicle;
generating, by a driver monitoring sensor in communication with the evaluation processor, driver status data that relates to a position, orientation, or condition of the driver;
generating, by an external monitoring sensor in communication with the evaluation processor, external interaction data relating to interaction of the driver with an external environment;
computing, by the evaluation processor, a driver rating based upon the driving dynamics data and the driver status data and the external interaction data; and
generating, by the evaluation processor, an alert to the driver or to a remote system based on the driving dynamics data and the external interaction data.

16. The method of claim 15, wherein the driving dynamics data includes at least one of: braking data, acceleration data, maximum speed, a stability control event, a forward collision alert, distance from other vehicles, seatbelt usage, lane keeping, or data regarding compliance with a speed limit.

17. The method of claim 15, wherein the driver status data includes at least one of: attention zone, driver engagement, secondary tasks of the driver, hands on a steering wheel, impairment of the driver, drowsiness of the driver, cognitive load of the driver, emotion of the driver, or alert responsiveness of the driver.

18. The method of claim 15, wherein the external interaction data includes at least one of: driver awareness of imminent events, looking for pedestrians at crosswalks, checking blind spots before lane changes, full stop at stop signs, or running a red light.

19. The method of claim 15, further comprising determining a direction that the driver is looking based on data from a camera, with the camera positioned such that the driver is in a field of view of the camera.

20. The method of claim 15, further comprising determining driver contact with a steering wheel of the vehicle.
